(19) United States
(12) Patent Application Publication
(10) Pub. No.: US 2014/0371074 A1
(43) Pub. Date: Dec. 18, 2014

(54) METHOD TO INCREASE PLANT YIELD

(71) Applicant: John Hugh McCleery Wilson, Albion, IA (US)

(72) Inventor: John Hugh McCleery Wilson, Albion, IA (US)

(21) Appl. No.: 14/240,644

(22) PCT Filed: Feb. 14, 2013
(86) PCT No.: PCT/US2013/026106

§ 371 Date: Feb. 24, 2014

Related U.S. Application Data
(60) Provisional application No. 61/598,757, filed on Feb. 14, 2012.
(60) Provisional application No. 61/612,690, filed on Mar. 19, 2012.

(51) Int. Cl. A01N 37/38; A01C 1/06; C05G 3/02

(52) U.S. Cl. CPC A01N 37/38; C05G 3/02; A01C 1/06
USPC 504/323; 47/57.6

(57) ABSTRACT

A method for increasing crop yield using plant growth regulators is disclosed. The invention relates to plant growth regulators including but not limited to auxins, cytokinins, gibberellins, ethylene and abscisic acid and any combination thereof. Auxin forms include but are not limited to phenoxy herbicide, phenoxy herbicide esters, and herbicides mixed with surfactants and fertilizers. The invention relates to the application of the plant growth regulators to seed, soil and seedlings. The invention further relates to using different application rates and combinations of the plant growth regulators to seeds, soil, seedlings and plants.

### CROSS REFERENCE TO RELATED APPLICATIONS

This application claims the benefit of priority from U.S. provisional patent applications Ser. Nos. 61/598,757, filed on Feb. 14, 2012 and 61/612,690, filed on Mar. 19, 2012, which are incorporated herein by reference in their entirety.

### BACKGROUND OF THE INVENTION

The present invention relates to a new and distinctive method for increasing plant yield by treating plants with plant growth regulators. All publications cited in this application are herein incorporated by reference.

Increasing yield by promoting the growth of crops and increasing the yield per unit area is an important task in agricultural production. Generally, major elements essential for plant growth, such as nitrogen, phosphorous and potassium, are incorporated into a fertilizer and supplied to plants, but the amount and yield of grown crops is typically limited even if the concentration of the nutrient elements in the fertilizer is increased. Additionally, by using fertilizer in large amounts, excess elements are leached into the soil, thus worsening the balance of absorption and causing a reduction in plant growth. Further, leached elements may cause downstream pollution. Thus, alternative methods to increase crop yield are highly desirable.

The growth and development of a plant are influenced by genetic factors, external environmental factors, and chemical hormones inside the plant. Plant hormones are chemical messengers that affect a plant's ability to respond to its environment. Hormones are organic compounds that are effective at very low concentration; they are usually synthesized in one part of the plant and are transported to another location. Hormones interact with specific target tissues to cause physiological responses, such as growth or fruit ripening. Each response is often the result of two or more hormones acting together.

Because hormones stimulate or inhibit plant growth, many botanists also refer to them as plant growth regulators. Many plant growth regulators can be synthesized in the laboratory, increasing the quantity of plant growth regulators available for commercial applications. Botanists recognize five major groups of plant growth regulators: auxins, cytokinins, gibberellins, ethylene, and abscisic acid.

Auxins can be divided into six major groups: indole acids, naphthalene acids, phenoxy carboxylic acids, benzoic acids, picolinic acid derivatives, and the quinoline carboxylic acids. The first group contains the natural product indole-3-acetic acid (IAA). IAA is the most important naturally occurring auxin, but its use in plant cell culture media is limited because it is highly unstable in plants and quickly degrades when exposed to light. The naphthalene acids (NAA) are used in research, but are not commercially available as herbicides. The other groups contain many well known herbicides: phenoxy carboxylic acids (2,4-Dichlorophenoxyacetic acid (2,4-D), 2,4,5-T, 2,4-DB, dichlorprop, 2-Methyl-4-chlorophenoxyacetic acid (MCPA), MCPB, mecoprop), benzoic acids (dicamba, chloramben), picolinic acids (aminopyralid, clopyralid, picloram, triclopyr), quinoline carboxylic acids (quinclorac), and one yet to be named family (aminocyclopyrachlor). These compounds are often called auxinic herbicides.

2,4-Dichlorophenoxyacetic acid (2,4-D) is a common systemic herbicide used in the control of broadleaf weeds. It is a member of the phenoxy family of auxinic herbicides and is manufactured from chloroacetic acid and 2,4-dichlorophenol. It is the most widely used herbicide in the world, and the third most commonly used in North America. 2,4-D is a highly selective herbicide that is toxic to broad leafed plants (dicots), but generally less harmful to grasses (monocots).

2,4-D is a synthetic auxin and as such it is often used in laboratories for plant research and as a supplement in plant cell culture media. Auxins are important growth hormones, involved in cell division, growth and differentiation in plants. 2,4-D is absorbed through the leaves and is translocated to the meristems of the plant where uncontrolled, unsustainable growth ensues, causing stem curl-over, leaf withering, and eventual plant death. 2,4-D is typically applied as an amine salt, but more potent ester versions exist as well. It is therefore desirable for a novel use to be developed for increasing crop yield using plant growth regulators.

### SUMMARY OF THE INVENTION

The present invention provides a method for increasing dicot crop yield per plant by treating plants with an effective amount of plant growth regulators. Treating plants in the present invention includes the treatment of soil, plants, and seeds coated with a plant growth regulator.

It is an aspect of the present invention to provide a method of treating plants with plant growth regulators in concentrations to enhance growth and yield.

It is an aspect of the present invention to provide a method of treating plants with auxins in concentrations to enhance growth and yield.

It is an aspect of the present invention to provide a method of treating plants with phenoxy herbicides in concentrations to enhance growth and yield.

The invention further relates to a method of plant treatment with all forms of the phenoxy herbicide 2,4-D, including the acid and ester forms and all other versions thereof.

The invention further relates to a method of treatment with 2,4-D mixed with surfactant to increase dicot plant yield.

The invention further relates to a method of treatment with 2,4-D mixed with fertilizer to increase dicot plant yield.

It is a further aspect of this invention to use 2,4-D in a seed treatment or seed coating.

It is an aspect of this invention to use 2,4-D in a seed treatment or seed coating at an application rate of between 0.0001 mg and 2.5 mg of active 2,4-D per seed. This is the same as 0.0000308 pounds acid equivalent 2,4-D per acre to 0.770925 pounds acid equivalent 2,4-D per acre for soybeans planted at a normal seeding rate per acre.

It is a further aspect of this invention to apply 2,4-D to the soil pre-planting by methods including but not limited to: drizzling, soil spraying, soil injection with a knife or other means, or as side dressing.

It is a further aspect of this invention to apply 2,4-D to the soil at the time of planting by methods including but not limited to: drizzling, soil spraying, soil injection with a knife or other means, or as side dressing.

It is a further aspect of this invention to apply 2,4-D to the soil post planting by methods including but not limited to: drizzling, soil spraying, soil injection with a knife or other means, or as side dressing.

It is also an aspect of this invention to use 2,4-D in a seed treatment or seed coating and to apply 2,4-D to the soil pre-planting, at the time of planting and/or post planting.

It is an aspect of this invention to apply 2,4-D to the soil an unlimited number of times at any time between planting and 3 weeks prior to harvest, preferably applying between 1 to 6 times, and most preferably applying between 1 to 3 times per growing season.

It is an aspect of this invention to apply 2,4-D to the soil adjacent to plants at between 0.1 lb and 10.0 lb of acid equivalent 2,4-D concentration rates on a per acre basis.

It is a further aspect of this invention to increase yield by using phenoxy herbicides that kill dicots by applying the phenoxy herbicide in a manner as described herein to stimulate growth of dicot plants.

These and other aspects, as well as the scope, nature, and utilization of the claimed invention will be apparent to those skilled in the art from the following detailed description and appended claims.

### DETAILED DESCRIPTION OF THE INVENTION

In the description and examples that follow, a number of terms are used. In order to provide a clear and consistent understanding of the specification and claims, including the scope to be given such terms, the following definitions are provided:

2,4-Dichlorophenoxyacetic acid (2,4-D). A synthetic auxin in the phenoxy family of auxinic herbicides used as a common systemic herbicide in the control of broadleaf weeds. 2,4-D is used to selectively kills dicots when applied directly to the plant, but not monocots. 2,4-D is formulated primarily as an amine salt in an aqueous solution or as an ester in an emulsifiable concentrate. An example of an ester of 2,4-D is 2,4-D LV4. The concentration of 2,4-D is typically given in acid equivalent of 2,4-D per acre.

2,4-D with surfactant. Any form of 2,4-D mixed with a surfactant.

Abscisic acid (ABA). ABA plays a role in dormancy development in embryos, buds and bulbs, and in leaf abscission. When used in tissue culture, ABA inhibits the growth of shoots and the germination of embryos.

Acid equivalent (a.e.). For 2,4-D labeling, refers to the equivalent amount of the acid version of 2,4-D. As used herein, refers to the amount of active ingredient of 2,4-D.

Active ingredient. As used herein, active ingredient of 2,4-D refers to the active amount of 2,4-D, usually given in units of acid equivalent.

Auxins. A group of plant growth regulators that promote callus growth, cell division, cell enlargement, adventitious buds, and lateral rooting. Endogenous auxins are auxins that occur naturally. Exogenous auxins are auxins that are man-made or synthetic. Examples of auxins include, but are not limited to: 1-naphthaleneacetic acid; 1-naphthaleneacetic acid, K-salt; 1-napthol; 2,4-dichlorophenoxyacetic acid (2,4-D); 2,4-DB; 2,4-DEP; 2,3,5-triiodobenzoic acid; 2,4,5-trichlorophenoxyacetic acid; 2-naphthoxyacetic acid; 2-naphthoxyacetic acid sodium salt; 3-chloro-4-hydroxyphenylacetic acid; 3-indoleacetic acid; 4-biphenylacetic acid; 4-chlorophenoxyacetic acid (4-CPA); 4-hydroxyphenylacetic acid; 6-benzylaminopurine; Auxindole™; α-naphthaleneacetic acid, K-salt; β-naphthoxyacetic acid; ρ-chlorophenoxyacetic acid; dicamba; dichlorprop; fenoprop; indole-3-acetic acid (IAA); indole-3-acetyl-DL-aspartic acid; indole-3-acetyl-DL-tryptophan; indole-3-acetyl-L-alanine; indole-3-acetyl-L-valine; indole-3-butyric acid (IBA); indole-3-butyric acid, K-salt; indole-3-propionic acid; α-naphthaleneacetic acid; methyl indole-3-acetate; naphthaleneacetamide; naphthaleneacetic acid (NAA); phenylacetic acid; picloram; potassium naphthenate; and sodium naphthenate.

Average yield. As used herein, average yield means the average weight of seed harvested from one dicot plant.

Bactericides. Bactericides are materials that help to reduce damage to seed, seedlings or plants caused by bacteria. An example includes, but it not limited to, streptomycin.

Batch type treating equipment. A type of treating equipment where a given quantity of seed enters the equipment in a single mass, and then spins in a chamber where the entire quantity of seed receives the desired materials, often applied in a sequential fashion allowing time for each material to mix with the seed before the next material is added until the entire quantity of seed exits in one mass.

Biological materials. Biological products are any of a number of living bacteria, fungi or other organisms that are placed on the seed and/or soil to improve plant performance. An example includes, but is not limited to, YIELD SHIELD®.

BU/A. Bushels per Acre. The seed yield in bushels/acre is the actual yield of the grain at harvest.

Callus. An unorganized, proliferate mass of differentiated plant cells.

Cell. Cell as used herein includes a plant cell, whether isolated, in tissue culture or incorporated in a plant or plant part.

Commercial seed treating operation. A facility that is exclusively used for the handling and treating of seed.

Continuous flow treating equipment. A piece of equipment that applies treatment to seed that is continuously moving toward an exit point.

Cotyledon. A cotyledon is a type of seed leaf. The cotyledon contains the food storage tissues of the seed.

Cytokinins A group of plant growth regulators that regulate growth and morphogenesis and stimulate cell division. Cytokinins are often used in combination with auxins. Examples of cytokinins include, but are not limited to: 4-hydroxyphenethyl alcohol; 4-CPPU; 6-benzylaminopurine (BA); 6-(γ,γ-dimethylallylamino)purine (2iP); 2-iP-2HCl; adenine; adenine hemisulfate; benzyladenine; kinetin; meta-topolin; N6-benzoyladenine; N-benzyl-9-(2-tetrahydropyranyl) adenine (BPA); N-(2-chloro-4-pyridyl)-N-phenylurea; thidiazuron (TDZ); zeatin; zeatin riboside; zeatin riboside, trans-isomer; and zeatin, trans-isomer.

Dicot. A flowering plant with two cotyledons. Examples include but are not limited to: soybean (Glycine spp), cotton (Gossypium spp), sunflower (Helianthus spp), potato (Solanum spp), grapes (Vitis spp), beans (Phaseolus), melon (Cucumis spp), pepper (Capsicum spp), strawberry (Fragaria spp), tomato (Solanum spp), and cabbage, canola, cauliflower, broccoli (Brassica spp).

Down-stream treating facility. A facility at or near the grower that treats seed in response to a grower's request and is often located at a seed dealer or a cooperative.

Effective amount. As used herein, an effective amount is that amount sufficient so that the yield from the dicot plant is increased.

Encapsulation. The use of chemical, physical or both chemical and physical materials to surround or encompass an active ingredient.

Ester. Any of a class of organic compounds corresponding to the inorganic salts and formed from an organic acid and an alcohol.

Ethylene. A natural plant hormone that affects the growth, development, ripening, and senescence of plants.

Explant. Plant tissue removed from its original site and transferred to an artificial medium for growth or maintenance.

Fertilizer. Any organic or inorganic material of natural or synthetic origin that is added to a soil to supply one or more plant nutrients essential to the growth of plants. Examples include, but are not limited to, manure and nitrogen, phosphorus, and potassium compounds.

Fungicides. A product developed to control fungi and is applied to seed and/or soil. Examples include, but are not limited to, TRILEX® and ALLEGIANCE®.

Furrow. A trench, rut, groove or narrow depression made in the ground by a plow, planter, grain drill, or side-dress applicator.

Gibberellins. Plant growth regulators that influence cell elongation. Examples of gibberellins include, but are not limited to: gibberellic acid (GA₃), gibberellins and gibberellins A4+A7 (GA_{4/7}). Gibberellin inhibitors include, but are not limited to: ancymidol; chlormequat chloride; daminozide; flurprimidol; and uniconazole.

Herbicide. A chemical pesticide used to kill unwanted plants that act by interfering with the growth of the plant.

Hormones. Growth regulators, generally synthetic in occurrence that strongly affects growth. Examples include, but are not limited to, auxins, cytokinins, and gibberellins.

Hydrophilic. Pertaining to the property of attracting or associating preferentially with water molecules, a quality possessed by polar radicals or ions.

Hypocotyl. A hypocotyl is the portion of an embryo or seedling between the cotyledons and the root. Therefore, it can be considered a transition zone between shoot and root.

Insecticide. A chemical used to control certain insects and is applied to seed and/or soil. Examples include, but are not limited to, GAUCHO® or CRUISER®.

Ionic surfactant. A surfactant having a hydrophilic polar head group that is ionic; anionic surfactants have a negatively charged head group, while cationic surfactants have a positively charged head group.

Isomer. Any of two or more substances that are composed of the same elements in the same proportions but differ in properties because of differences in the arrangement of atoms.

Lipophilic. Showing a marked affinity for, or solubility in, lipids.

Megacluster node. Refers to a node containing many pods.

Mixture. As used herein, mixture refers to plant growth regulators, such as 2,4-D, combined with surfactant, fertilizer, insecticide, or water, or any combination thereof.

Monocot. A flowering plant with one cotyledon.

Nematode control materials. Nematodes are microscopic worms of the phylum Nematoda that comprise 85% of all animals, and most live in the soil and attack plants. A nematode control material can be applied to the seed and/or soil to reduce damage. Examples include, but are not limited to, VOTIVO® and AVICTA®.

Node. The point on a stem where a leaf is attached or has been attached; a joint.

Nonionic surfactant. A surfactant having uncharged hydrophilic head groups.

Phenoxy herbicide. When sprayed on broad-leaf plants phenoxy herbicides induce rapid, uncontrolled growth, eventually killing them, but leave crops such as wheat or corn unaffected. Chemically they are acids, and are typically applied in an ester or salt form. Examples include but are not limited to 2,4-dichlorophenoxyacetic acid (2,4-D), 2-Methyl-4-chlorophenoxyacetic acid (MCPA), 2-(2-Methyl-4-chlorophenoxy)propionic acids (MCPP) and any variations thereof.

Plant. As used herein, the term “plant” includes reference to an immature or mature whole plant, including a plant from which seed, grain, or anthers have been removed. Seed or embryo that will produce the plant is also considered to be the plant.

Plant extracts. Plant extracts are naturally occurring substances that are extracted from specific plants that can have an effect on seedling growth by directly controlling diseases or by stimulating plant growth. An example includes, but is not limited to, HEADS-UPC).

Plant growth regulators. Any substance or mixture of substances intended, through physiological action, for accelerating or retarding the rate of growth or maturation or for otherwise altering the behavior of ornamental or crop plants or the produce thereof, but not including substances intended as plant nutrients, trace elements, nutritional chemicals, plant inoculants, or soil amendments. Plant growth regulators include, but are not limited to, auxins, cytokinins, gibberellins, ethylene and abscisic acid.

Plant parts. As used herein, the term “plant parts” (or a soybean plant, or a part thereof) includes but is not limited to protoplasts, leaves, stems, roots, root tips, anthers, pistils, seed, grain, embryo, pollen, ovules, cotyledon, hypocotyl, pod, flower, shoot, tissue, petiole, cells, meristematic cells, and the like.

Plant tissue culture. The growth or maintenance of plant cells, tissues, organs or whole plants in vitro.

Planting aid. A planting aid would include talc, graphite, waxes and other materials that make seed slicker and help to keep the seed dry during the planting process.

Pod. This refers to the fruit of a soybean plant. A pod consists of the hull or shell (pericarp) and the soybean seeds.

R1 stage. Refers to the beginning flowering when plants have at least one flower on any node.

Regeneration. In plant cultures, a morphogenetic response to a stimulus that results in the products of organs, embryos, or whole plants.

Seed applied fertilizers. Seed applied fertilizers are any plant nutrient that is applied to seed that offers early season nutrient availability.

Seed coating. As used herein, refers to the mixture of plant growth regulators, such as 2,4-D in any form, with or without addition of surfactant or fertilizer, applied to dicot seed prior to planting. Also referred to as seed treatment.

Seed coating build-up systems. Seed coating build-up systems include any process that adds between 1% to greater than 300% increase to the original seed weight applied in a specific piece of equipment that allows for multiple applications of the build-up materials such as a batch type seed treater. Seed build-up coatings are widely used in the vegetable industry to improve seed planting, fertilizer application and appearance.

Seed treatment polymers. Seed treatment polymers include many different polymers that are added to seed to hold the seed treatment materials on the seed, reduce dust and improve seed flow ability. An example is PRESISE SEED FINISHER 10000.

Seed Yield (Bushels/Acre). The yield in bushels/acre is the actual yield of the grain at harvest.

Seeds Per Pound. Soybean seeds vary in seed size; therefore, the number of seeds required to make up one pound also varies. The number of seeds per pound affects the pounds of seed required to plant a given area and can also impact end uses.

Side dressing. Refers to giving growing plants a dose of fertilizer or other chemical treatment beyond whatever food or treatment was applied when planted.

Soil. As used herein, soil refers to any substrate in which seed is planted or grown that encourages growth and development. Various substrates for germinating seeds are well known in the art.

Soybean bag. As used herein, soybean bag is synonymous with a soybean unit. A soybean bag refers to a bag of 140,000 soybean seeds.

Surfactant. Refers to a compound that lowers the surface tension of a liquid, the interfacial tension between two liquids, or that between a liquid and a solid. Surfactants may act as detergents, wetting agents, emulsifiers, foaming agents, and dispersants. Surfactants consist of a hydrophobic tail portion, usually a long-chain hydrocarbon, and a hydrophilic polar head group. As used herein, surfactant also includes oil.

Treated plants. As used herein, refers to plants that have been grown from seed treated with plant growth regulator(s), such as 2,4-D, or any form thereof. Treated plants also includes any plants where plant growth regulator such as 2,4-D has been applied to the soil adjacent to the plant. Treated plants also includes plants side-dressed with plant growth regulator, such as 2,4-D.

Treated seed. As used herein, refers to seeds that have been treated with plant growth regulator(s), such as 2,4-D, or any form thereof.

Trifoliate. Having three leaves or leaf-like parts.

Untreated seed. Seed as harvested with nothing added to it. Also called naked seed.

Yield per plant. As used herein, yield per plant means the weight of seed harvested from one dicot plant.

Yield per acre. As used herein, yield per acre refers to the weight of seed harvested from an acre of plants.

The present invention is related to a method of using plant growth regulators to increase the yield of dicot plants. The plant growth regulator utilized in one embodiment of the present invention is the auxinic herbicide 2,4-Dichlorophenoxyacetic acid (2,4-D), and any variation thereof, such as acid or ester forms, which retain the ability to increase the yield of dicot plants; however, any plant growth regulator that retains the ability to increase the yield of dicot plants alone or in combination with other plant growth regulators may be used. Also included are mixtures of 2,4-D with surfactants, which may enhance the uptake of the auxinic herbicide. In one embodiment, the surfactant utilized is a nonionic surfactant, such as TRADITION 93®, but any nonionic surfactant may be used. In other embodiments of the invention, mixtures of 2,4-D with fertilizers are used, especially when used as a side-dressing for growing plants. In further embodiments, 2,4-D is used in combination with other plant growth regulators.

Auxins are very widely used in plant tissue culture and usually form an integral part of nutrient media. Auxin molecules present in cells may trigger responses directly through stimulation or inhibition of the expression of sets of certain genes, or by means independent of gene expression (see Hardtke, CS, BioEssays, 2007, 29(11):1115-23). Auxins typically act in concert with, or in opposition to, other plant hormones. For example, auxins promote, mainly in combination with cytokinins, the growth of calli, cell suspensions and organs, and also regulate the direction of morphogenesis. At the cellular level, auxins control basic processes such as cell division and cell elongation. Since they are capable of initiating cell division they are involved in the formation of meristems giving rise to either unorganized tissue, or defined organs. Auxins are also often used to promote initiation of adventitious roots, and are the active ingredient of the commercial preparations used in horticulture to root stem cuttings. They can also be used to promote uniform flowering and fruit set, and to prevent premature fruit drop.

The choice of auxins, whether alone or in combination with other auxins or cytokinins, and the concentration administered depends on: the type of growth and/or development required; the rate of uptake and of transport of the applied auxin to the target tissue; the inactivation (oxidation and/or conjugation) of auxin in the medium and within the explant; the natural levels and the endogenous synthesis within the explant; the sensitivity of the plant tissue to auxin; and the interaction, if any, between applied auxins and the natural endogenous substances. The balance of plant growth regulators is the decisive factor for determining the effects on plant growth.

In most auxin effects, a bell-shaped concentration/activity curve can be observed. At low concentrations (0.1-10 μM) the effect usually increases with concentration, but concentrations higher than 10 μM are often inhibitory. This inhibitory effect is usually due to an increase in ethylene production at higher auxin concentrations. In tissue culture, depending on other hormones present in the medium, changes in auxin concentrations may change the type of growth, e.g., stimulation of root formation may switch to callus induction, etc.

Aside from their use in plant tissue culture, auxinic herbicides are the most widely used herbicides in the world. They are used to selectively control broadleaf weeds in grass crops, including corn, wheat barley, oat, sorghum, rice, sugarcane, pasture, rangeland, and turf. Auxinic herbicides are all weak acid herbicides that are primarily applied postemergence and translocate via the phloem to the growing points and other sink regions in the plant. Much like the effects seen in tissue culture, at low doses, the growth regulator herbicides have a stimulatory effect on plant and cell growth similar to that of IAA. However, the increased concentrations of auxinic herbicides used to control weeds cause growth disturbance and potentially lethal damage to plants. Symptoms include leaf chlorosis, altered stomatal function, stem tissue proliferation, root initiation in stem tissue, disintegration of root tissues, leaf cupping, stunted leaves, and abnormal apical growth. Many of these are secondary effects. In addition, auxin herbicides can cause plugging of the phloem, growth inhibition, and tip and stem swelling. (see Cobb, A., Auxin-type herbicides, Herbicides and Plant Physiology, Chapman Hall, 1992:82-106; Sterling, T M and Hall, J C, Mechanism of action of natural auxins and the auxinic herbicides, In:Roe, R M, et al, eds, Herbicide Activity:Toxicology, Biochemistry and Molecular Biology, Amsterdam:IOS Press, 1997:111-141; Grossman, K, Mediation of herbicide effects by hormone interactions, J Plant Growth Regul, 2003, 22:109-122)

It is an embodiment of the current invention to enhance dicot crop yield using auxins. Auxins are generally used in plant tissue culture at a concentration range of between 0.01-10.0 mg/L. In the present invention where auxinic herbicides such as 2,4-D are applied to the seed and soil, the concentration range used is correlated to and can be similar to that used in tissue culture, with the concentrations for seed treatment ranging from 0.0001 mg to 2.5 mg per seed and the concentrations for soil or side-dressing treatment ranging from 0.5 mg to 24 mg per acre. When added in appropriate concentrations auxins may regulate cell elongation, tissue swelling, cell division, formation of adventitious roots, inhibition of adventitious and axillary shoot formation, callus initiation and growth, and induction of embryogenesis. Examples of auxins include, but are not limited to: 1-naphthaleneacetic acid; 1-naphthaleneacetic acid, K-salt; 1-napthol; 2,4-dichlorophenoxyacetic acid (2,4-D); 2,4-DB; 2,4-DEP; 2,3,5-triiodobenzoic acid; 2,4,5-trichlorophenoxyacetic acid; 2-naphthoxyacetic acid; 2-naphthoxyacetic acid sodium salt; 3-chloro-4-hydroxyphenylacetic acid; 3-indoleacetic acid; 4-biphenylacetic acid; 4-chlorophenoxyacetic acid (4-CPA); 4-hydroxyphenylacetic acid; 6-benzylaminopurine; Auxindole™; α-naphthaleneacetic acid, K-salt; β-naphthoxyacetic acid; ρ-chlorophenoxyacetic acid; dicamba; dichlorprop; fenoprop; indole-3-acetic acid (IAA); indole-3-acetyl-DL-aspartic acid; indole-3-acetyl-DL-tryptophan; indole-3-acetyl-L-alanine; indole-3-acetyl-L-valine; indole-3-butyric acid (IBA); indole-3-butyric acid, K-salt; indole-3-propionic acid; α-naphthaleneacetic acid; methyl indole-3-acetate; naphthaleneacetamide; naphthaleneacetic acid (NAA); phenylacetic acid; picloram; potassium naphthenate; and sodium naphthenate.

It is a further embodiment of the current invention to enhance dicot crop yield using cytokinins Cytokinins are generally used in plant tissue culture at a concentration range of between 0.1-10.0 mg/L and are often used in combination with auxins. When used in combination with auxins, the ratio of auxins to cytokinins plays an important role in the effects on plant growth. In the present invention where chemicals are applied to the seed and soil, the concentration range used is correlated to and can be similar to that used in tissue culture, with the concentrations for seed treatment ranging from 0.0001 mg to 2.5 mg per seed and the concentrations for soil or side-dressing treatment ranging from 0.5 mg to 24 mg per acre. When added in appropriate concentrations cytokinins may regulate cell division, stimulate auxiliary and adventitious shoot proliferation, regulate differentiation, inhibit root formation, activate RNA synthesis, and stimulate protein and enzyme activity. Examples of cytokinins include, but are not limited to: 4-hydroxyphenethyl alcohol; 4-CPPU; 6-benzylaminopurine (BA); 6-(γ,γ-dimethylallylamino)purine (2iP); 2-iP-2HCl; adenine; adenine hemisulfate; benzyladenine; kinetin; meta-topolin; N6-benzoyladenine; N-benzyl-9-(2-tetrahydropyranyl) adenine (BPA); N-(2-chloro-4-pyridyl)-N-phenylurea; thidiazuron (TDZ); zeatin; zeatin riboside; zeatin riboside, trans-isomer; and zeatin, trans-isomer.

It is a further embodiment of the current invention to enhance dicot crop yield using gibberellins. Gibberellins are generally used in plant tissue culture at a concentration range of between 0.01-5.0 mg/L. In the present invention where chemicals are applied to the seed and soil, the concentration range used is correlated to and can be similar to that used in tissue culture, with the concentrations for seed treatment ranging from 0.0001 mg to 2.5 mg per seed and the concentrations for soil or side-dressing treatment ranging from 0.5 mg to 24 mg per acre. Gibberellins are generally used to promote stem elongation, flowering, and breaking dormancy of seeds, buds, corms, and bulbs. There are over 90 forms of gibberellins, but GA₃ is the most commonly used form. Examples of gibberellins include, but are not limited to: gibberellic acid (GA₃), gibberellins and gibberellins A4+A7 (GA_{4/7}). Gibberellin inhibitors include, but are not limited to: ancymidol; chlormequat chloride; daminozide; flurprimidol; and uniconazole.

It is an embodiment of the current invention to enhance dicot crop yield using abscisic acid. Abscisic acid (ABA) is generally used in plant tissue culture at a concentration range of between 0.1-10.0 mg/L. In the present invention where chemicals are applied to the seed and soil, the concentration range used is correlated to and can be similar to that used in tissue culture, with the concentrations for seed treatment ranging from 0.0001 mg to 2.5 mg per seed and the concentrations for soil or side-dressing treatment ranging from 0.5 mg to 24 mg per acre. ABA plays a role in dormancy development in embryos, buds and bulbs, and in leaf abscission. When used in tissue culture, ABA inhibits the growth of shoots and the germination of embryos.

It is a further embodiment of the current invention to enhance dicot crop yield using other plant growth regulators. In general, plant growth regulators are used in plant tissue culture at a concentration range of between 0.01-10.0 mg/L. In the present invention where chemicals are applied to the seed and soil, the concentration range used is correlated to and can be similar to that used in tissue culture, with the concentrations for seed treatment ranging from 0.0001 mg to 2.5 mg per seed and the concentrations for soil or side-dressing treatment ranging from 0.5 mg to 24 mg per acre. Other plant growth regulators include, but are not limited to: antiauxins, such as 2,3,5-tri-iodobenzoic acid and clofibric acid; antimitotics, such as colchicine, oryzalin, and triflualin; defoliants, such as calcium cyanamide, dimethipin, endothal, ethephon, merphos, metoxuron, pentachlorophenol, thidiazuron, and tribufos; dwarfing agents, such as ancymidol, CCC, paclobutrazol, and trinexapac-ethyl; ethylene; ethylene inhibitors, such as 1-methylcyclopropene and aviglycine; ethylene releasers, such as ACC, etacelasil, ethephon, and glyoxime; gametocides, such as fenridazonand maleic hydrazide; growth inhibitors such as ancymidol, butralin, carbaryl, chlorphonium, chlorpropham, dikegulac, flumetralin, fluoridamid, fosamine, glyphosine, isopyrimol, jasmonic acid, maleic hydrazide, mepiquat, piproctanyl, prohydroj asom, propham, tiaojiean, 2,3,5-tri-iodobenzoic acid, and the morphactins, chlorfluren, chlorflurenol, dichlorflurenol, and flurenol; growth retardants, such as chlormequat, daminozide, flurprimidol, mefluidide, paclobutrazol, tetcyclacis, and uniconazole; growth stimulators, such as brassinolide, brassinolide-ethyl, DCPTA, forchlorfenuron, hymexazol, prosuler, pyripropanol, and triacontanol; and polyamines, such as N,N′-bis(2-aminoethyl)-1,3-propanediamine, putrescine, putrescine dihydrochloride, spermidine, spermidine trihydrochloride, spermine, spermine dehydrate, and spermine tetrahydrochloride. Additionally, there are a number of unclassified plant growth regulators, including: bachmedesh; benzofluor; buminafos; carvone; choline chloride; ciobutide; clofencet; cloxyfonac; cyanamide; cyclanilide; cycloheximide; cyprosulfamide; epocholeone; ethychlozate; ethylene; fuphenthiourea; furalane; heptopargil; holosulf; inabenfide; karetazan; lead arsenate; methasulfocarb; prohexadione; pydanon; sintofen; triapenthenol; and trinexapac.

It is a further embodiment of the current invention to enhance dicot crop yield using a combination of plant growth regulators. The concentrations and ratios of the plant growth regulators used and the subsequent effects on endogenous plant hormones determine the effects on plant growth.

This invention is related to methods for enhancing dicot crop yield using a plant growth regulator, such as 2,4-D, an ester of 2,4-D or any auxinic or phenoxy herbicide. An accidental spill of 2,4-D Ester LV4 and a nonionic surfactant in a soybean field had the unexpected result of increased flowering and poding for the affected soybeans. Further investigation found that 2,4-D when applied to the soil or in a seed treatment had a positive effect on the seedling and yield per plant.

The positive effects on growth were very unexpected because 2,4-D is a highly selective herbicide that is toxic to broad leafed plants (dicots), but generally less harmful to grasses (monocots). 2,4-D is typically applied as a foliar spray to control weeds. The effectiveness of the phenoxy herbicides is also the reason that off-target spray drift from its application can cause serious injury to broadleaf crops, native vegetation and ornamental plants. The current invention has multiple embodiments that describe different uses for phenoxy herbicides, that when applied directly to the soil and/or used in a seed treatment stimulates the reproductive cycle of dicots, resulting in increased yield. In other embodiments, the present invention can be used to increase yield on any dicot, examples of which include but are not limited to: soybean (Glycine spp), cotton (Gossypium spp), sunflower (Helianthus spp), potato (Solanum spp), canola, cauliflower, broccoli (Brassica spp), grapes (Vitis spp), beans (Phaseolus), melon (Cucumis spp), pepper (Capsicum spp), strawberry (Fragaria spp), and tomato (Solanum spp).

Commercially available herbicide compositions include a very large variety of active herbicide compounds. In various embodiments of the present invention, herbicide compositions are prepared from a variety of different types of precursor compositions, and can be commercially available and used in a variety of different types of compositions, including wettable powders, water dispersible granules, granules, aqueous solutions, water soluble powders, emulsifiable concentrates, oil-based flowables, concentrated emulsions, suspo-emulsions, emulsions, suspensions, suspension concentrates, mixtures, dispersions, and microemulsions, as well as others. Any of these different types of compositions may have different advantages or disadvantages depending on what type of active ingredients the herbicide includes.

In further embodiments of the present invention, active herbicide ingredients such as these and others are prepared from and used in the form of solid and liquid compositions including, as mentioned above, different forms of emulsions, suspensions, suspension concentrates, mixtures, dispersions, and microemulsions, etc. With regard to the liquid forms, the active ingredient (herbicide compound) is generally suspended or dissolved in a liquid, with the active herbicide compound taking the chemical form of a salt or ester, depending on which form is either soluble or suspendable in such a liquid compositions. For example, for commercial use the low volatile ester herbicide SWB™ 2,4-D LV4 is provided at an equivalent of 3.76 pounds of the 2,4 isomer of 2,4-D per gallon (Winfield Solutions, LLC, St. Paul, Minn.) and is sold as a liquid that can be diluted using water or certain types of oil, as well as addition of a surfactant. The ester version of 2,4-D called Low Vol 4 is provided at an equivalent of 3.8 pounds of 2,4-D acid per gallon (Loveland products, Greeley, Colo.). The ester version 2,4-D LV6 is typically provided at a concentration of 5.6 pounds of 2,4-Dichlorophenoxyacetic acid per gallon (Winfield Solutions, LLC, St. Paul, Minn.).

In further embodiments of the present invention, surfactants are added to liquid and dry, flowable herbicides in order to help the herbicides enter the leaf surface, and can also be used to disperse herbicides in water. The surfactants include a lipophilic portion compatible with many herbicides and a hydrophilic portion compatible with water. Depending on the herbicide, the surfactant used is suitable either ionic or nonionic.

As used in the method of the present invention, nonionic surfactants include a molecular structure where the nature of chemical bonds within the structure imparts hydrophilic and lipophilic features to the surfactant. Nonionic surfactants do not have a net charge. Nonionic surfactants are usually products of a petrochemical process. Consequently, the nonionic surfactants tend to be expensive and to have limited environmental compatibility. Nonionic surfactants include sorbitan fatty ester, polyoxyalkylene sorbitan fatty ester, polyoxyalkylene fatty ester, glycerin fatty ester, polyoxyalkylene glycerin fatty ester, polyglycerin fatty ester, polyoxyalkylene polyglycerin fatty ester, sorbitol fatty ester, polyoxyalkylene sorbitol fatty ester, sucrose fatty ester, resin acid ester, polyoxyalkylene resin acid ester, polyoxyalkylene alkyl ether, polyoxyalkylene alkyl phenyl ether, alkyl(poly)glycoside, polyoxyalkylene alkyl(poly)glycoside, alkyl alkanol amide, sugarpbased fatty acid amide, etc. In one embodiment of the present invention a nonionic surfactant is used, such as TRADITION 93®. TRADITION 93® is a 93% active nonionic surfactant that contains alkylarylpolyethoxyethanol, free fatty acids, 2-butoxyethanol, propylene glycol, and dimethylpolysiloxane and is particularly useful for delivery of herbicides.

Surfactants interact with herbicides in a number of ways both before and after application to a crop. In addition to having used as an emulsifier, a surfactant may act as a penetrant, spreader, sticker, stabilizer, wetting agent, dispersant and defoamer. The surfactant may affect a rate of drying of a droplet on a plant and the nature of a residue, liquid or crystal. The surfactant may influence the weathering characteristics of the herbicide, including rewetting characteristics.

In one embodiment of the present invention, 2,4-D LV4 is mixed with a nonionic surfactant. The surfactant may be any nonionic surfactant that is mixed with the 2,4-D solution at any ratio, such as 1:5. For example, a surfactant to 2,4-D solution ratio of 0.2 pint:1 pint or 6.4 pint:32 pint.

It is an embodiment of the present invention that a phenoxy herbicide mixture be applied directly to both the seed and to the soil with the dicot plant seeds. To facilitate this, it is one preferred embodiment that the mixture be applied to the seeds prior to planting or introduced into or next to the seed furrows when the seeds are planted. One advantageous technique is that the treatment be applied to the seeds through the use of a suitable coating mechanism or binder prior to the seeds being planted. The process of coating seed with such a treatment is generally well known to those skilled in the art. Alternatively, the phenoxy herbicide mixture may be applied directly into or next to the furrows into which the seed is planted. The process for applying such treatments directly into the furrows during seed planting is also generally well known in the art.

In another embodiment of the present invention, the phenoxy herbicide, such as 2,4-D with surfactant, may be applied directly to the soil at planting and at post planting. It is worth noting that application of 2,4-D directly to a dicot plant will result in plant death; in the field 2,4-D is applied to the surface of the soil between plants at distances ranging from less than 0.1 inch to within 100 feet of the plants by drizzling, soil spraying, or soil injection with a knife or other means. The 2,4-D can also be applied in every row or alternatively, in every 2, 3, 4 or more rows. 2,4-D treatment can be applied to or adjacent to any dicot grown in the field or in greenhouses. For example, 2,4-D treatment can be applied in the field to soybean plant populations having anywhere between 40,000 to 200,000 plants per acre.

It is a further embodiment of the present invention that the phenoxy herbicide mixture be applied as a side-dressing to dicot plants after germination. In this embodiment, the phenoxy herbicide is preferably mixed with fertilizer and applied post planting.

It is another embodiment of the present invention that the phenoxy herbicide mixture be: 1) applied directly to the seed and/or to the soil adjacent to the dicot plant seeds, 2) applied to the soil after planting dicot seeds, and 3) applied as a side-dressing to dicot plants after germination, or any variation thereof, which retain the ability to increase the yield of dicot plants.

In another embodiment, when used post planting, the herbicide is applied at any time between planting and 3 weeks prior to harvest, typically between 1 to 5 times prior to harvest, and preferably between 1 to 3 times prior to harvest. For example, 2,4-D may be applied to the soil in the furrow between rows at the time of planting, and may also subsequently be applied to the soil from 1-4 more times during growth.

Whether the phenoxy herbicide mixture is coated directly on the seed, applied to the soil into or next to the furrows, and/or as a side-dressing, the mixture is preferably diluted to provide a sufficient quantity of material so as to allow easy human handling.

The application rate of the phenoxy herbicide mixture onto the seed, soil or side-dressing should be sufficient to enhance the yield of the plant. An effective amount of phenoxy herbicide mixture should be used. An effective amount is that amount sufficient so that the yield from the dicot plant is increased.

In one embodiment of the invention the phenoxy herbicide, such as 2,4-D, is used at a rate of between 0.47 and 7.52 pounds acid equivalent (a.e.) of 2,4-D per acre, where the 2,4-D is supplied at 0.47 pounds a.e. of 2,4-D per pint. At this rate of application, soybean plants have set excessive numbers of pods at every node. In one embodiment, the herbicide is used at a rate of between 0.1 and 10.0 pounds a.e. of 2,4-D per acre. For example, 0.1, 0.5, 1.0, 1.7, 2.8, 3.9, 4.9, 6.7, 8.5, 9.3, or 10.0 pounds a.e. of 2,4-D per acre including any integer or fraction thereof, including any application rate between 0.1 and 10.0 pounds.

In a further embodiment of the invention, 2,4-D is applied directly to the seed in one or more of several seed application methods. The application of 2,4-D to the seed will be at a rate of 0.0001 milligrams of active 2,4-D per seed to 2.5 milligrams of active 2,4-D per seed. This is the same as 0.0000308 pounds acid equivalent 2,4-D per acre to 0.770925 pounds acid equivalent 2,4-D per acre for soybeans planted at a normal seeding rate per acre.

In one embodiment of the present invention, this application of between 0.0001 mg of active 2,4-D per seed to 2.5 mg of active 2,4-D per seed can be to untreated (naked) seed. In another embodiment, the application of between 0.0001 mg of active 2,4-D per seed to 2.5 mg of active 2,4-D per seed can be with or on top of previously treated seed. Seed treatment may occur in a liquid or dry state at a commercial seed treating operation (continuous flow or batch type treating equipment), at a down-stream treating facility, in the field, or at any point from the harvest of the seed until and including the time it has been planted into the soil. The 2,4-D may be applied to the seed as the only material placed on the seed, or it may be part of a seed treatment combination that may include one or more fungicides, may include one or more insecticides, may include one or more nematode control products, may include one or more biological products, may include one or more plant extract materials, one or more bactericides, one or more seed applied fertilizers, may include one or more seed treatment polymers, may be part of a seed coat build-up system or layered on the seed in a seed coat build-up system, may be part of a planting aid (talc, graphite or other drying or lubricating material).

### EXAMPLES

The data set forth in the Examples demonstrate that mixtures of the auxinic herbicide, 2,4-D will be effective in increasing the yield of dicot plants when used in accordance with the present invention.

### Example 1

### Field Results

The following example describes the outcome from an accidental chemical spill that unexpectedly resulted in increased crop yield in Laurel, Iowa in 2011. A chemical mixture containing 0.47 pounds a.e. of 2,4-D Ester LV4 and a nonionic surfactant called TRADITION 93® was spilled next to a soybean field of variety Asgrow 3231 nine days after planting. The same night, a one-inch rainfall washed the chemical spill down the field and killed the soybean plants. Later in the year it was much easier to walk down the chemical spill to check the soybean plants for bugs, diseases, etc. It was then noticed that the soybean plants on the edge of the spill were flowering and poding at a surprisingly high rate. In this example, the soybean plant population treated from the 2,4-D spill had a density of 71,500 plants per acre with a yield of 83.35 bushels per acre, while the untreated soybean population had a density of 148,000 plants per acre with a yield of 70.87 bushels per acre, as shown in Table 1, Plot 1. The lower density of the treated population was due to physical damage and not environmental damage. Table 1 shows results from two plots of the same variety of soybean, Asgrow 3231. Each plot was 2 rows wide and 12 feet long and was either treated or untreated with a soil application of 2,4-D Ester LV4 and a nonionic surfactant, TRADITION 93®. Column 1 shows the plot number, column 2 shows the yield of treated plants in bushels/acre, column 3 shows the yield of untreated plants in bushels/acre, and column 4 shows the difference in yield between the two treatments. As shown in Table 1, the treatment with 2,4-D chemical mixture greatly increased the soybean yield by an average of 9.84 bushels per acre, even when the plant population of the treated plot was 71,500 plants per acre versus 148,000 plants per acre for the untreated plants.

TABLE 1

| | Treated yield at | Untreated yield at | |
|---|---|---|---|
| | 71,500 plants | 148,000 plants | |
| | per acre | per acre | Yield |
| Asgrow 3231 Plot | (Bushels/acre) | (Bushels/acre) | difference |
| 1 | 83.35 | 70.87 | 12.48 |
| 2 | 74.34 | 67.14 | 7.20 |
| Average | 78.85 | 69.00 | 9.84 |

2012 was a poor year for field testing due to scarce rainfall in the early stages of growth, which likely prevented the 2,4-D mixture from properly penetrating the soil and roots of plants. Table 2 shows the results of 2,4-D LV4 application to the soil of field planted soybean plants under the more normal growing conditions at two locations in 2012. Plants were treated by drizzling via low pressure spraying the 2,4-D solution onto the soil along each side of the rows when plants are at the R1 stage of growth. The date of planting was May 15, 2012 and the date of harvest was Oct. 2, 2012 at plots in Alexander, Iowa (Table 2a) and Laurel, Iowa (Table 2b). Plants were grown from Roundup Ready seed and were sprayed with glyphosate for weed control. Plants were treated with between 1X and 5.5X of 2,4-D solution mixed with crop oil at 15.3 ounces of 2,4-D Low Vol 4 plus 0.32 ounces crop oil per gallon, where 1X is equivalent to approximately 0.45 pounds acid equivalent of 2,4-D. Two repetitions were performed at different plots. For Tables 2a and 2b, column 1 shows the amount of 2,4-D mixture applied, column 2 shows the cultivar, column 3 shows the moisture percentage of the harvested seed for repetition 1, column 4 shows the weight in pounds of harvested seed for repetition 1, column 5 shows the yield in bushels per acre for repetition 1, column 6 shows the moisture percentage of the harvested seed for repetition 2, column 7 shows the weight in pounds of harvested seed for repetition 2, column 8 shows the yield in bushels per acre for repetition 2, column 9 shows the average yield in bushels per acre, column 10 shows the moisture percentage of the harvested seed for the untreated controls, column 11 shows the weight in pounds of harvested seed for the untreated controls, and column 12 shows the yield in bushels per acre of the untreated controls. The moisture percentages were used in correcting each yield to a 13% moisture basis.

TABLE 2a

| | | Repetition 1 | | | Repetition 2 | | | Average | Untreated control | | |
|---|---|---|---|---|---|---|---|---|---|---|---|
| | | Moisture | Weight | Yield | Moisture | Weight | Yield | Yield | Moisture | Weight | Yield |
| 2,4-D amount | Cultivar | (%) | (Lbs) | (Bu/A) | (%) | (Lbs) | (Bu/A) | (Bu/A) | (%) | (Lbs) | (Bu/A) |
| 1.0X Rate | L2084R2 | 4.3 | 4.3 | 49.06 | 4.9 | 4.1 | 46.48 | 47.77 | 5.1 | 4 | 45.25 |
| 1.0X Rate | L2711R2X | 4.1 | 3.7 | 42.30 | 4.9 | 4.5 | 51.02 | 46.66 | 4.9 | 5 | 56.69 |
| 1.5X Rate | L2084R2 | 4.3 | 3.4 | 38.79 | 5.2 | 5 | 56.51 | 47.65 | 4.9 | 4.9 | 55.55 |
| 1.5X Rate | L2711R2X | 4.2 | 3.9 | 44.54 | 5 | 5.4 | 61.16 | 52.85 | 4.7 | 4 | 45.44 |
| 2.0X Rate | L2084R2 | 4.5 | 4.5 | 51.23 | 5.1 | 4.6 | 52.04 | 51.64 | 4.9 | 3.7 | 41.95 |
| 2.0X Rate | L2711R2X | | | | 5 | 4.1 | 46.43 | 46.43 | 4.8 | 4.1 | 46.53 |
| 2.5X Rate | L2084R2 | 4.3 | 3.1 | 35.37 | 5.2 | 3.7 | 41.81 | 38.59 | 4.9 | 3.1 | 35.14 |
| 2.5X Rate | L2711R2X | 4.5 | 3.1 | 35.29 | 4.9 | 3.9 | 44.21 | 39.75 | 4.7 | 3.4 | 38.63 |
| 3.0X Rate | L2084R2 | 4.4 | 3.5 | 39.89 | 5.1 | 4.1 | 46.38 | 43.14 | 4.8 | 3.4 | 38.59 |
| 3.0X Rate | L2711R2X | 4.6 | 3.7 | 42.08 | 5.1 | 4.3 | 48.65 | 45.36 | 4.6 | 3.6 | 40.94 |
| 3.5X Rate | L2084R2 | 4.9 | 3.4 | 38.55 | | | | 38.55 | 5.10 | 4 | 45.25 |
| 3.5X Rate | L2711R2X | 4.6 | 4.2 | 47.77 | | | | 47.77 | 4.90 | 5 | 56.69 |
| 4.0X Rate | L2084R2 | 4.8 | 4.5 | 51.07 | | | | 51.07 | 4.90 | 4.9 | 55.55 |
| 4.0X Rate | L2711R2X | 4.8 | 5.4 | 61.28 | | | | 61.28 | 4.70 | 4 | 45.44 |
| 4.5X Rate | L2084R2 | 4.9 | 4.7 | 53.28 | | | | 53.28 | 4.90 | 3.7 | 41.95 |
| 4.5X Rate | L2711R2X | 4.7 | 4.7 | 53.40 | | | | 53.40 | 4.80 | 4.1 | 46.53 |
| 5.0X Rate | L2084R2 | 4.7 | 4.1 | 46.58 | | | | 46.58 | 4.90 | 3.1 | 35.14 |
| 5.0X Rate | L2711R2X | 4.6 | 4.3 | 48.90 | | | | 48.90 | 4.70 | 3.4 | 38.63 |
| 5.5X Rate | L2084R2 | 4.8 | 4.2 | 47.67 | | | | 47.67 | 4.80 | 3.4 | 38.59 |
| 5.5X Rate | L2711R2X | 4.9 | 4.1 | 46.48 | | | | 46.48 | 4.60 | 3.6 | 40.94 |
| Average | L2084R2 | 4.59 | 4.0 | 45.15 | 5.10 | 4.3 | 48.65 | 46.59 | 4.92 | 3.8 | 43.30 |
| Average | L2711R2X | 4.56 | 4.1 | 46.89 | 4.98 | 4.4 | 50.29 | 48.89 | 4.74 | 4.0 | 45.65 |
| Overall location average | | 4.57 | 4.0 | 45.97 | 5.04 | 4.4 | 49.47 | 47.74 | 4.83 | 3.9 | 44.47 |

TABLE 2b

| | | Repetition 1 | | | Repetition 2 | | | Average | Untreated control | | |
|---|---|---|---|---|---|---|---|---|---|---|---|
| | | Moisture | Weight | Yield | Moisture | Weight | Yield | Yield | Moisture | Weight | Yield |
| 2,4-D amount | Cultivar | (%) | (Lbs) | (Bu/A) | (%) | (Lbs) | (Bu/A) | (Bu/A) | (%) | (Lbs) | (Bu/A) |
| 1.0X Rate | L2711R2X | 6.1 | 5.6 | 62.69 | 6.1 | 6.0 | 67.16 | 64.93 | 6.3 | 6.3 | 70.37 |
| 1.0X Rate | L3385R2 | 8.1 | 6.7 | 73.40 | 7.6 | 6.5 | 71.60 | 72.50 | 7 | 6.7 | 74.28 |
| 1.5X Rate | L2711R2X | 6.1 | 6.6 | 73.88 | 6.0 | 5.4 | 60.51 | 67.20 | 6.4 | 6.7 | 74.76 |
| 1.5X Rate | L3385R2 | 8.3 | 6.8 | 74.34 | 6.3 | 6.9 | 77.07 | 75.70 | 7.3 | 7 | 77.36 |
| 2.0X Rate | L2711R2X | 5.8 | 5.7 | 64.01 | 5.9 | 5.6 | 62.82 | 63.41 | 6 | 6 | 67.24 |
| 2.0X Rate | L3385R2 | 6.5 | 6.3 | 70.22 | 6.1 | 6.4 | 71.64 | 70.93 | 6.4 | 6.9 | 76.99 |
| 2.5X Rate | L2711R2X | 6.0 | 5.7 | 63.87 | 5.9 | 5.6 | 62.82 | 63.35 | 6.3 | 5.6 | 62.55 |
| 2.5X Rate | L3385R2 | 6.0 | 6.3 | 70.60 | 5.5 | 6.5 | 73.23 | 71.91 | 5.8 | 6.3 | 70.75 |
| 3.0X Rate | L2711R2X | 6.2 | 5.5 | 61.50 | 5.9 | 5.9 | 66.19 | 63.84 | 6.3 | 5.8 | 64.79 |
| 3.0X Rate | L3385R2 | 5.8 | 6.6 | 74.12 | 5.7 | 6.2 | 69.70 | 71.91 | 6 | 6.9 | 77.32 |
| 3.5X Rate | L2711R2X | 6.2 | 5.7 | 63.74 | | | | 63.74 | 6.30 | 6.3 | 70.37 |
| 3.5X Rate | L3385R2 | 8.2 | 6.3 | 68.94 | | | | 68.94 | 7.00 | 6.7 | 74.28 |
| 4.0X Rate | L2711R2X | 6.1 | 6.1 | 68.28 | | | | 68.28 | 6.40 | 6.7 | 74.76 |
| 4.0X Rate | L3385R2 | 6.4 | 6.7 | 74.76 | | | | 74.76 | 7.30 | 7 | 77.36 |
| 4.5X Rate | L2711R2X | 6.0 | 6.3 | 70.60 | | | | 70.60 | 6.00 | 6 | 67.24 |
| 4.5X Rate | L3385R2 | 7.5 | 6.6 | 72.78 | | | | 72.78 | 6.40 | 6.9 | 76.99 |
| 5.0X Rate | L2711R2X | 6.0 | 5.9 | 66.11 | | | | 66.11 | 6.30 | 5.6 | 62.55 |
| 5.0X Rate | L3385R2 | 5.8 | 6.6 | 74.12 | | | | 74.12 | 5.80 | 6.3 | 70.75 |
| 5.5X Rate | L2711R2X | 6.1 | 5.4 | 60.45 | | | | 60.45 | 6.30 | 5.8 | 64.79 |
| 5.5X Rate | L3385R2 | 6.3 | 6.3 | 70.37 | | | | 70.37 | 6.00 | 6.9 | 77.32 |
| Average | L2711R2X | 6.06 | 5.9 | 65.51 | 5.96 | 5.7 | 63.90 | 65.19 | 6.26 | 6.1 | 67.94 |
| Average | L3385R2 | 6.89 | 6.5 | 72.36 | 6.24 | 6.5 | 72.65 | 72.39 | 6.50 | 6.8 | 75.34 |
| Overall location average | | 6.48 | 6.2 | 68.94 | 6.10 | 6.1 | 68.27 | 68.79 | 6.38 | 6.4 | 71.64 |

As shown in Table 2a, treatment of plants with 2,4-D mixture increases plant yield.

Table 3 shows the results of soybean plants treated with 2,4-D mixture as a side dress in Laurel, Iowa. Plants were grown from Roundup Ready variety Asgrow 2933 seed that was treated with accelron (Monsanto) prior to planting. Plants were side dressed by application with a 3-point cultivator modified to spray on the ground in front of the shanks, the shanks then mix the 2,4-D mixture with the soil and move the mixture closer to the plant roots. Plants were treated with between 1X and 4X of 2,4-D Low Vol 4 solution, where 1X is equivalent to approximately 0.19 pounds acid equivalent of 2,4-D. Plants were grown with a row width of 30 inches and row length of 562 feet. Table 3, column 1 shows the characteristic, column 2 shows the results for the untreated control and columns 3-6 show the results for plants treated at 1X, 2X, 3X, and 4X 2,4-D solution, respectively.

TABLE 3

| Characteristic | Control | 1X | 2X | 3X | 4X |
|---|---|---|---|---|---|
| Harvested weight (g) | 290 | 1292 | 1016 | 1844 | 2088 |
| Harvest moisture (%) | 9.2 | 8.8 | 9.4 | 8.3 | 8.7 |
| Number of rows | 3 | 12 | 8 | 16 | 16 |
| Yield (Bushels/acre at | 52.5 | 58.3 | 68.3 | 62.8 | 70.8 |
| 13% moisture) | | | | | |
| Percent of control | 100% | 110% | 130% | 120% | 135% |

As shown in Table 3, side dress treatment with 2,4-D solution greatly increases plant yield.

### Example 2

### Greenhouse Results

The following example shows results of a 2,4-D LV4 application to the soil of potted plants planted and grown in a greenhouse. Soybean variety ‘Latham EX32124 CystX’ was planted in 8.5 inch diameter pots and grown under lights in a greenhouse. Four seeds each were planted and later thinned to 2 plants per plot for each of 5 treatment rates of 0.47, 0.94, 1.88, 3.76, and 7.52 pounds a.e. of 2,4-D per acre. Plants were treated by drizzling the 2,4-D solution approximately 3 to 4 inches from the plant when they developed the second set of trifoliate leaves, and were observed for number of pods, as well as damage caused by the treatment. The treated plants were observed to mature slower and stay greener for approximately 2 weeks longer than untreated plants. When the soybean plants were at the stage of growth in which pods are 3/16 inch length at one of the two uppermost nodes, the number of beginning pods was observed. Table 4, column 1 shows the pod description, column 2 shows the pod results for control (untreated) plants, column 3 shows the pod results for plants treated with 0.47 lbs a.e. of 2,4-D, column 4 shows pod results for plants treated with 0.94 lbs a.e. of 2,4-D, column 5 shows pod results for plants treated with 1.88 lbs a.e. of 2,4-D, column 6 shows pod results for plants treated with 3.76 lbs a.e. of 2,4-D, and column 7 shows pod results for plants treated with 7.52 lbs a.e. of 2,4-D.

TABLE 4

| | | 0.47 lbs | 0.94 lbs | 1.88 lbs | 3.76 lbs | 7.52 lbs |
|---|---|---|---|---|---|---|
| Description | Control | a.e. | a.e. | a.e. | a.e. | a.e. |
| Beginning pods | Normal | Normal | Huge | Huge | Normal | Normal |
| | | | clusters | clusters | | |
| | | | of pods | of pods | | |

As shown in Table 4, the optimal rate of herbicide application was 0.94 and 1.88 pounds a.e. of 2,4-D, each resulting in huge clusters of pods (megaclusters). At this stage, household fertilizer was added to the plants along with water, and the number of nodes and pods was observed approximately ten days later, as shown in Table 3. Pod counts were for 2 plants per pot. Table 5, column 1 shows the pod description, column 2 shows the pod results for control (untreated) plants, column 3 shows the pod results for plants treated with 0.47 lbs a.e. of 2,4-D, column 4 shows pod results for plants treated with 0.94 lbs a.e. of 2,4-D, column 5 shows pod results for plants treated with 1.88 lbs a.e. of 2,4-D, column 6 shows pod results for plants treated with 3.76 lbs a.e. of 2,4-D, and column 7 shows pod results for plants treated with 7.52 lbs a.e. of 2,4-D.

TABLE 5

| | | | | | | |
|---|---|---|---|---|---|---|
| | | 0.47 lbs | 0.94 lbs | 1.88 lbs | 3.76 lbs | 7.52 lbs |
| Description | Control | a.e. | a.e. | a.e. | a.e. | a.e. |

Immature pod counts on 2 plants/pot

| | | | | | | |
|---|---|---|---|---|---|---|
| Normal nodes | 8 | 7 | 5 | 5 | 5 | 7 |
| Megacluster nodes | 0 | 0 | 6 | 5 | 3 | 2 |
| Total nodes with pods | 8 | 7 | 11 | 10 | 8 | 9 |
| Pods on normal nodes | 40 | 27 | 18 | 17 | 24 | 25 |
| Pods on megacluster nodes | 0 | 0 | 75 | 30 | 27 | 18 |
| Total pods per pot (2 plants) | 40 | 27 | 93 | 49 | 51 | 43 |
| Average pods per normal node | 5 | 3.9 | 3.6 | 3.4 | 4.8 | 3.6 |
| Average pods per megacluster node | N/A | N/A | 12.5 | 6.0 | 9.0 | 9.0 |

As shown in Table 5, the optimal rate of application was 0.94 pounds a.e. of 2,4-D, resulting in megacluster nodes and over double the number of pods versus untreated plants. Additionally, the 1.88, 3.76, and 7.52 pounds a.e. of 2,4-D per acre rates also show an increased total number of pods per plant compared to the control rate. It should be noted that plants treated at the 7.52 pounds a.e. rate showed some yellowing of leaves.

### Example 3

### Use of Surfactant

The following is an example of increased yield in field grown soybean plants after application of 2,4-D with surfactant. Soybean seeds are planted in a field and grown to seedling emergence, followed by application of 0.47, 0.94, 1.41, 1.88 and 2.35 pounds a.e. of 2,4-D per acre dilutions of 2,4-D with surfactant to the soil by drizzling. Plants are observed for number of pods per plant and results are recorded and displayed as an average per plant.

### Example 4

### Evaluation of 2,4-D as Seed Treatment

An initial step in evaluating 2,4-D as a seed treatment to increase yield of dicot plants involves doing a germination study to evaluate seeds of soybean varieties that are treated with 2,4-D in a titration rate study compared to an untreated control and a standard treatment. This germination study includes 2,4-D rates of 0.1, 0.01 and 0.001 mg/seed (these rates are equal to 0.0308 pounds of acid equivalent 2,4-D per acre, 0.00308 pounds of acid equivalent 2,4-D per acre and 0.000308 pounds of acid equivalent 2,4-D per acre under normal soybean planting rates per acre). The present invention aims to use similar concentrations of plant growth regulators in the seed treatment as that used in the soil treatment. These rates are applied to untreated (naked) seed as part of a slurry treatment where the slurry is comprised of a fungicide system, an insecticide system and a polymer system; and as a dry application where the 2,4-D is placed on a talc/graphite mixture at the concentrations of 0.1, 0.01 and 0.001 mg/seed, which is accomplished by determining how much total talc/graphite mixture will stick on the seed and then adding the appropriate amount of 2,4-D to achieve the proper rate, and applying this dry material to seed previously treated with a fungicide/insecticide/polymer system. The seed treated with the liquid 2,4-D is stored for one week before placing in a warm germination test, while the dry treatment is applied to the treated seed immediately before the warm germination trial is initiated. The seed is then planted at the same time that the warm germination is initiated in a laboratory soil test trial where seed are placed in a silt loam soil and the seed are placed in the soil at a depth similar to field conditions (approximately 1½ inches deep) and the space between seeds is similar to a field situation (1 to 6 inches between seeds in a row and 7.5 to 30 inches between rows to simulate both drilled soybeans and normal width row soybeans). At least 3 seed sources are utilized in these trials, and additional seed sources would add value.

Ratings made at the end of the trials include both negative and positive plant growth (the trials are extended one week after the initial germination counts to allow the plants to demonstrate growth differences). Seedlings grown in the soil substrate demonstrate higher germination counts and more positive growth than the warm germination plants that have been grown in paper towels or some other artificial substrate such as Kimpack, a cellulose wadding paper.

Results of this first set of trials determine the degree of phytotoxicity that may occur from the application of 2,4-D to soybean seed, and determine if placing seed into the soil may reduce any observed phytotoxicity. If no phytotoxicity is observed in these trials, then the trial is repeated with the 2,4-D titration rates increased to higher rates per seed.

### Example 5

### Batch Treater and Build-Up Technology

The following is an example of using a batch type treater and build-up technology to both safen the seed from any negative affect from the 2,4-D and allow the dosage of 2,4-D to be increased relative to the rates that are acceptable on untreated seed or seed treated with standard fungicides/insecticides/polymers/etc. Materials and methods currently exist for applying build-up coatings to vegetable and other seeds, and this technology is used to layer the build-up materials (often clays or some other earthen material) with a high level adhesive seed polymer to establish a protective layer between the seed coat and the 2,4-D. Once the initial safening layer is in place, a series of layers is placed on the seed that alternating from 2,4-D to build-up materials and then back to the 2,4-D until the total amount of 2,4-D applied to the seed is equal to 0.1 mg/seed, 0.01 mg/seed and 0.001 mg/seed (these rates are equal to 0.0308 pounds of acid equivalent 2,4-D per acre, 0.00308 pounds of acid equivalent 2,4-D per acre and 0.000308 pounds of acid equivalent 2,4-D per acre under normal soybean planting rates per acre). The final outside layer is the build-up material. Seeds treated in this manner are tested in a germination study to determine the optimal application rate to increase yield of the plant.

### Example 6

### Encapsulation

The following is an example that utilizes encapsulation technology where the 2,4-D is encapsulated in materials that will not allow the 2,4-D to escape the capsule until after the seed has been planted into the soil. This encapsulated 2,4-D is applied to the seed in such a way as to keep the capsule from breaking down during the treating or seed handling process. This example also includes a 2,4-D titration study looking at seed safety and growth differences over a wide range of 2,4-D application rates (0.1 mg/seed, 0.01 mg/seed and 0.001 mg/seed, these rates are equal to 0.0308 pounds of acid equivalent 2,4-D per acre, 0.00308 pounds of acid equivalent 2,4-D per acre and 0.000308 pounds of acid equivalent 2,4-D per acre under normal soybean planting rates per acre). Untreated seed and a standard seed treatment are included in this example. Seed safety evaluations are completed to determine the degree of phytotoxicity that may occur from the application of 2,4-D to soybean seed, and determine if placing seed into the soil may reduce any observed phytotoxicity, and treated seeds are placed in pots with limited numbers of seeds per pot (simulating field seed placement, that being planted approximately 1½ inches deep and 1 to 6 inches between seeds in a row and 7.5 to 30 inches between rows to simulate both drilled soybeans and normal width row soybeans), and grown in a greenhouse or a growth chamber until at least R2 or R3 with notes taken on any differences in blossom numbers or pod set numbers.

### Example 7

### Planting Treated Seed

Treatment rates used in the field trials are the highest rate that appeared safe in the germination and soil trials, plus one rate higher than the safest lab rate. These treatments are compared to the other methods of applying 2,4-D to soybeans in the field, and are combined with the other methods of applying 2,4-D to soybeans in the field. An untreated control and a standard seed treatment are used as the check. Trials are planted in at least three locations with different soil types, one in clay soil, one in a loam soil and one in a sandy soil. All treatments are planted on three different dates at each location. The first date is considered an early planting date for the area, the second date is considered a normal planting date for the area and the third date is considered a late planting date for the area. Stand counts for each treatment are made when the standard seed treatment has reached 50% emergence with additional counts made daily until it appears that all plants have emerged. An additional final count is made three weeks later to determine if any plants have died post emergence. Plants will be monitored throughout the growing season for differences in size, vigor, color and reproductive characteristics (blossom numbers and pod numbers), plant lodging and crop maturity. All treatments will be taken through yield with the yield data compared to the fungicide seed treatment control.

Table 6 shows the yield results when seeds are treated with 2,4-D prior to planting. Previously untreated soybean seeds were treated with between 1X to 10X of 2,4-D solution, where 1X is equivalent to approximately 0.0002968 pounds acid equivalent of 2,4-D. The seed variety was Latham 2767 Roundup Ready seeds and seeds were planted in Laurel, Iowa with a row width of 30 inches. Plants were sprayed with foliar insecticide and fungicide. Table 6, column 1 shows the characteristic, column 2 shows the results for the control (untreated) seeds, and columns 3-12 show the results for seeds treated with 1X, 2X, 3X, 4X, 5X, 6X, 7X, 8X, 9X, and 10X 2,4-D, respectively.

TABLE 6

| Characteristic | Control | 1X | 2X | 3X | 4X | 5X | 6X | 7X | 8X | 9X | 10X |
|---|---|---|---|---|---|---|---|---|---|---|---|
| Harvested | 95 | 125 | 90 | 100 | 100 | 105 | 110 | 105 | 110 | 100 | 95 |
| weight (g) | | | | | | | | | | | |
| Harvest | 12.1 | 12.7 | 15.6 | 18.7 | 20.5 | 22.4 | 21.2 | 24.1 | 24.3 | 22.6 | 20.3 |
| moisture (%) | | | | | | | | | | | |
| Yield | 46.45 | 60.71 | 42.26 | 45.23 | 44.23 | 45.33 | 48.22 | 44.36 | 46.32 | 43.06 | 42.12 |
| (Bushels/acre | | | | | | | | | | | |
| at 13% | | | | | | | | | | | |
| moisture) | | | | | | | | | | | |

As shown in Table 6, the 1X seed treatment had the greatest effect on yield, with an increase to 60.71 bushels per acre produced for the 1X treated seed compared to 46.45 bushels per acre produced for the untreated seed.

Table 7 shows the yield results when soybean seeds are treated with 2,4-D mixture prior to planting. Previously untreated soybean seeds were treated with between 0.01 ounces to 0.09 ounces of 2,4-D solution per 100 pounds of seed, in which 0.01 ounces is equivalent to 0.0002968 pounds acid equivalent of 2,4-D. The seed variety was L2438R2 and seeds were planted in Laurel, Iowa with a row width of 50 inches. Four rows were planted and the middle two rows were harvested. Table 7, column 1 shows the amount of 2,4-D in ounces, column 2 shows the average moisture in percent for the first repetition, column 3 shows the total harvested weight in pounds for the first repetition, column 4 shows the yield in bushels per acre for the first repetition, column 5 shows the average moisture in percent for the second repetition, column 6 shows the total weight in pounds for the second repetition, column 7 shows the yield in bushels per acre for the second repetition, and column 8 shows the total average yield in bushels per acre.

TABLE 7

| | Repetition 1 | | | Repetition 2 | | | |
|---|---|---|---|---|---|---|---|
| 2,4-D | Average | Total | | Average | Total | | Total |
| amount | moisture | weight | Yield | moisture | weight | Yield | yield |
| (ounces) | (%) | (pounds) | (Bu/acre) | (%) | (pounds) | (Bu/acre) | (Bu/acre) |
| 0 | 5.35 | 13.70 | 43.28 | | | | |
| 0.01 | 5.90 | 14.80 | 46.49 | 6.05 | 15.60 | 48.92 | 47.70 |
| 0.02 | 5.40 | 15.90 | 50.21 | 5.75 | 16.10 | 50.65 | 50.43 |
| 0.03 | 5.40 | 15.60 | 49.26 | 5.25 | 14.90 | 47.12 | 48.19 |
| 0.04 | 9.65 | 16.40 | 49.46 | 10.60 | 15.90 | 47.45 | 48.45 |
| 0.05 | 11.65 | 16.10 | 47.48 | 7.85 | 16.00 | 49.21 | 48.35 |
| 0.06 | 9.45 | 15.50 | 46.85 | 7.95 | 14.90 | 45.78 | 46.31 |
| 0.07 | 7.05 | 14.50 | 44.99 | 7.25 | 14.90 | 46.13 | 45.56 |
| 0.08 | 6.25 | 13.40 | 41.93 | 5.75 | 14.30 | 44.99 | 43.46 |
| 0.09 | 6.70 | 14.90 | 46.40 | 6.20 | 14.00 | 43.83 | 45.12 |
| Average | 7.49 | 15.23 | 47.01 | 6.96 | 15.18 | 47.12 | 47.06 |

As shown in Table 7, the application of 0.02 ounces of 2,4-D mixture had the greatest effect on yield with an average of 50.43 bushels per acre produced from seed treated with 2,4-D, compared to 43.28 bushels per acre produced from untreated seed.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A method for increasing plant yield comprising:
a. planting seeds of a dicot plant in soil;
b. germinating said seeds into plants;
c. applying a plant growth regulator to the soil adjacent to germinated plants to produce treated plants; and
d. growing the treated plants, whereby the yield of the treated plants is increased.

2. The method of claim 1, wherein the plant growth regulator is selected from the group consisting of auxin, cytokinin, gibberellins, ethylene and abscisic acid, preferably wherein the auxin is a phenoxy herbicide, and more preferably wherein the phenoxy herbicide is any form of 2,4-Dichlorophenoxyacetic acid.

3. (canceled)

4. (canceled)

5. The method of claim 2, wherein the herbicide is applied at a rate of between 0.1 and 10.0 pounds acid equivalent 2,4-D per acre.

6. (canceled)

7. (canceled)

8. The method of claim 1, wherein the method further comprises mixing the plant growth regulator with a surfactant.

9. (canceled)

10. (canceled)

11. The method of claim 1, wherein the method further comprises mixing the plant growth regulator with a fertilizer.

12. The method of claim 1, wherein the method further comprises applying the plant growth regulator to the soil before, at, or after planting.

13. (canceled)

14. (canceled)

15. (canceled)

16. A method for increasing plant yield comprising:
a. treating seeds of dicot plants with a plant growth regulator;
b. planting one or more treated seeds in soil;
c. growing said treated seeds into plants, whereby the yield of the plants is increased.

17. The method of claim 16, wherein the plant growth regulator is selected from the group consisting of auxin, cytokinin, gibberellins, ethylene and abscisic acid, preferably wherein the auxin is a phenoxy herbicide, and more preferably wherein the phenoxy herbicide is any form of 2,4-Dichlorophenoxyacetic acid.

18. (canceled)

19. (canceled)

20. The method of claim 17, wherein the herbicide is applied in a liquid or dry state to the seed at a rate of between 0.0001 mg active ingredient per seed and 2.5 mg active ingredient per seed.

21. The method of claim 16, wherein the herbicide is applied to the seed by a method selected from the group consisting of a batch treater, a continuous flow treater, a down-stream treater, a farm treater and by directly placing the herbicide alone or in combination with a carrier on the seed during the planting operation.

22. (canceled)

23. The method of claim 16, wherein the herbicide is applied to the seed in combination with one or more biological materials, wherein said one or more biological materials is selected from fungicide seed treatment materials, insecticide seed treatment materials, nematode seed treatment materials, bactericides, plant extract materials or mixtures thereof.

24. (canceled)

25. The method of claim 17, wherein the herbicide is applied to the seed in combination with one or more seed applied fertilizer products.

26. The method of claim 16, wherein the herbicide is applied to the seed in combination with one or more seed treatment polymer coatings or in combination with one or more seed coat build-up coatings, or layered between polymer and/or seed build-up coatings.

27. (canceled)

28. The method of claim 16, further comprising:
d. applying a plant growth regulator to the soil adjacent to germinated plants to produce treated plants; and
e. growing the treated plants, whereby the yield of the treated plants is increased.

29. The method of claim 28, wherein the plant growth regulator is selected from the group consisting of auxin, cytokinin, gibberellins, ethylene and abscisic acid, preferably wherein the auxin is a phenoxy herbicide, and more preferably wherein the phenoxy herbicide is any form of 2,4-Dichlorophenoxyacetic acid.

30. (canceled)

31. (canceled)

32. The method of claim 29, wherein the herbicide is applied in a liquid or dry state to the seed at a rate of between 0.0001 mg active ingredient per seed and 2.5 mg active ingredient per seed.

33. The method of claim 29, wherein the herbicide is applied at a rate of between 0.1 and 10.0 pounds acid equivalent 2,4-D per acre.

34. (canceled)

35. (canceled)

36. (canceled)

37. (canceled)

38. The method of claim 28, wherein the method further comprises mixing the phenoxy herbicide with a surfactant.

39. (canceled)

40. (canceled)

41. The method of claim 28, wherein the method further comprises mixing the herbicide with a fertilizer.

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. A product comprising:
a plant growth regulator;
optionally, a surfactant and a fertilizer; and
at least one dicot seed, plant or plant part.

59. The product of claim 58, wherein the plant growth regulator is selected from the group consisting of auxin, cytokinin, gibberellins, ethylene and abscisic acid, preferably wherein the auxin is a phenoxy herbicide, and more preferably wherein the phenoxy herbicide is any form of 2,4-Dichlorophenoxyacetic acid.

60. (canceled)

61. (canceled)

62. (canceled)

63. (canceled)

64. (canceled)
